(19) United States
(12) Patent Application Publication
(10) Pub. No.: US 2010/0259145 A1
(43) Pub. Date: Oct. 14, 2010

(54) Modular Telecommunications Frame and Enclosure Assembly

(75) Inventors: Mark E. Martich, Greensboro, NC (US); Lars R. Larsen, Old Lyme, CT (US); Stewart A. Levesque, Scotland, CT (US)

Correspondence Address: MCCARTER & ENGLISH, LLP STAMFORD, CANTERBURY GREEN, 201 BROAD STREET, 9TH FLOOR, STAMFORD, CT, 06901, US

(73) Assignee: ORTRONICS, INC., New London, CT (US)

(21) Appl. No.: 12/824,279

(22) Filed: Jun. 28, 2010

Related U.S. Application Data
(62) Division of application No. 11/700,520, filed on Jan. 31, 2007.

(51) Int. Cl. A47B 81/00; A47B 96/00; B23P 19/04

(52) U.S. Cl. 312/245; 312/326; 29/428

(57) ABSTRACT

Assemblies and methods for mounting telecommunications equipment, such as patch panels is provided. A mounting assembly is disclosed including a swing gate adapted to host a plurality of telecommunications equipment. The swing gate is hingedly attached to a support frame by a pair of aligned hinges adapted to allow the swing gate to open and close. The support frame includes support members defining an opening for fitting telecommunications equipment within the support frame when the swing gate is closed. The support frame is adapted to be mounted with respect to various mounting locations such as a support structure of a raised floor or drop ceiling, a wall, and/or a cabinet. A cabinet adapted to enclose the support frame includes walls defining a cavity. At least one of the walls is a front door adapted to open and close and allow access to the swing gate when the front door is open. The cabinet is adapted to be mounted with respect to a raised floor, drop ceiling, or a wall. The hinges connecting the swing gate to the support frame are aligned crooked arm hinges positioning the swing gate off set from the front face of the support frame. An exemplary assembly includes a cabinet having walls defining a cavity. One of the walls is a front door adapted to open and close. A swing gate is hingedly connected to the cabinet by a pair of aligned crooked arm hinges. The cabinet is plenum rated defining at least one fire stopped cable opening for drop ceiling mounting.

### BACKGROUND

1. Technical Field

The present disclosure relates to assemblies and methods for efficient and accessible mounting of telecommunications equipment within a ceiling, floor and/or a telecommunications closet.

2. Background Art

Wiring and connected hardware are an integral part of a typical commercial building telecommunications wiring system. Wiring standards of Category 5 Transmission, for example, require that items, such as, modular jack panels be mounted for easy installation and service. A typical piece of equipment upon which modular jack panels or patch panels are mounted is a floor-to-ceiling relay rack. In many installations, a floor-to-ceiling relay rack is not warranted for the number of panels which are to be utilized.

A well-known piece of equipment for mounting a smaller number of panels is a wall rack typically mounted on a vertical wall. A wall rack generally includes a support frame which is fixed relative to the wall and a mounting frame connected to the support frame. The mounting frame has a plurality of modular jack panels, also known as patch panels, mounted thereon with the front of the panels exposed. Typically, the mounting frame is connected to the support frame by a pair of vertically aligned hinges on one side of the mounting frame and a locking latch on the opposite side of the mounting frame. When it is desired to reach the back of the jack panels, the locking latch is released, thereby releasing the one side of the mounting frame from the support frame so that the mounting frame may pivot on the vertically aligned hinges.

In some systems, telecommunications panels are mounted in a drop ceiling or a raised floor. When a mounting frame is mounted in a drop ceiling, it must be enclosed within a plenum-rated enclosure or cabinet to ensure compliance with fire codes associated with a given environment. In many system environments, it is desired to have the telecommunications equipment mounted within a cabinet for raised floor and/or wall rack embodiments as well. Certain ceiling enclosures mount the patch panels on the rear side of the front door of the enclosure. In such implementations, when a user swings the front door into an open position, the patch panels also swing out from the enclosure allowing access to the rear of the patch panels. The same mechanism may be used for wall or floor mounted systems.

Cabinets having patch panels mounted on the back side of the front door create several complications. When the door is in an open position, front side access to the patch panels is difficult. A further drawback associated with front door mounting involves increased movement and flexing of the rear side cabling associated with the patch panel. Whenever the front door swings open, the patch panels necessarily swing open along with any attached cabling. This creates increased wear and tear on the cabling system, potentially giving rise to unanticipated failures and/or a requirement for frequent replacement. It is a further disadvantage of current systems that a typical mounting frame will only open to a 90 degree angle relative to the closed position. Indeed, the enclosure or cabinet creates a physical block that does not allow the door to open further than 90 degrees. This makes patch panel access more difficult, especially in a floor installation.

Accordingly, a need exists for effective mounting frame assemblies and solutions capable of allowing convenient and efficient patch panel access for drop ceiling, raised floor, and/or wall rack installations. A need also exists for mounting frame assemblies and solutions that do not place undue stress/strain on cabling elements. These and other needs are met, and the disadvantages and/or limitations of prior art systems are addressed and/or overcome, by the assemblies and methods of the present disclosure.

### SUMMARY

The present disclosure describes effective assemblies and methods for mounting telecommunications equipment. In an exemplary embodiment, a telecommunications equipment mounting assembly includes a swing gate hingedly connected to a support frame by a pair of hinges allowing the swing gate to open and close. The swing gate is adapted to host a plurality of telecommunications equipment mounted onto the swing gate. The support frame includes support members defining an opening for the telecommunications equipment to securely fit within the support frame when the swing gate is closed. The support frame is adapted to be mounted to a particular mounting location.

An exemplary mounting location includes a cabinet having walls defining a cavity to receive the support frame. The cabinet is generally mounted to a member selected from the group consisting of a planar support structure of a drop ceiling, a planar support structure of a raised floor, and a wall, although alternative mounting members may be employed. At least one of the walls is a front door hingedly attached to at least one of the remaining walls by a pair of aligned hinges to allow the front door to open and close. The front door is adapted to allow access to the swing gate when the front door is open. In an exemplary embodiment, the mounting location is a wall and the support frame is mounted vertically. In a further exemplary embodiment, the mounting location is a support structure of a raised floor and the support frame is mounted horizontally.

Typically the hinges attaching the swing gate to the support frame are a pair of hinges positioning the swing gate offset from a front face of the support frame within the opening of the support frame. The hinges are adapted to: (i) allow for the swing gate to clear an enclosing side of a cabinet or a floor when opening the swing gate; and (ii) rotate to a greater than ninety degree angle relative to a front face of the support frame.

In an exemplary embodiment where the support frame is mounted within a cabinet, at least one of the walls is hingedly attached to a rear side of the cabinet by a pair of aligned pivoting hinges and is partially detachably connected to a front side of the cabinet by a pair of aligned disengaging latches adapted to allow the hingedly attached wall to open, thereby allowing side access to the swing gate and allowing equipment mounted on the swing gate to fully swing open without physical interference by the cabinet. In an exemplary embodiment, a control cylinder can be attached with respect to the swing gate and adapted to accommodate for the opening and closing speed of the swing gate.

An exemplary mounting assembly according to the present disclosure includes a front side enclosure having: (i) a top face; (ii) an opposite bottom face; (iii) a first side face; and (iv) an opposite second side face; wherein the faces are connected to define a substantially rectangular opening. The enclosure further includes a front door hingedly attached to the second side face by a pair of aligned hinges adapted to allow the front door to pivot along an axis to open and close. A swing gate adapted to host a plurality of telecommunications equipment members mounted onto the swing gate is hingedly connected to a support frame. The support frame includes support members defining an opening for the telecommunications equipment to securely fit within the support frame when the swing gate is closed. The enclosure at least partially encloses the support frame and allows front side access to the swing gate when the front door of the enclosure is open and allows for the swing gate to swing open allowing front and rear access to the telecommunications equipment mounted on the swing gate and access to the opening of the support frame. The support frame is adapted to be mounted onto a particular mounting location.

In an exemplary embodiment, the hinges connecting the swing gate to the support frame are a pair of aligned “crooked arm” hinges positioning the swing gate offset from a front face of the support frame within the opening of the support frame spaced away from the front door of the enclosure. The crooked arm hinges are adapted to: (i) allow for the swing gate to clear the side faces of the enclosure when opening the swing gate; and (ii) rotate to a greater than ninety degree angle relative to the plane of the front door of the enclosure. Typically, the swing gate pivots along an axis adjacent and perpendicular to the pivot axis of the front door of the enclosure. In an exemplary embodiment, the swing gate pivots along an axis opposite and parallel to the pivot axis of the front door of the enclosure.

In an exemplary embodiment, the support frame is mounted to a rear side enclosure adapted to attach to the front side enclosure to fully enclose the support frame and the telecommunications equipment mounted on the swing gate. The mounting location can be a drop ceiling having a planar support structure and a vertically spaced partition plane. The rear side enclosure is horizontally mounted to the support structure such that the front door of the front side enclosure is flush with the vertically spaced partition plane. The partition plane includes a plurality of ceiling tiles and the front door that is flush with the partition plane is generally adapted to substantially match the look of the ceiling tiles. When mounted in a drop ceiling, the rear side enclosure is plenum-rated defining at least one fire stopped opening to allow for telecommunication cables connecting to the telecommunication equipment to enter and exit the enclosed space created by the front and rear side enclosure.

In an exemplary embodiment, the mounting location is a wall and the support frame is mounted vertically with respect to the wall. When mounted with respect to a wall, the second side face of the enclosure is hingedly attached to a rear side of the enclosure by a pair of vertically aligned pivoting hinges and is partially detachably connected to a front side of the enclosure by a pair of vertically aligned disengaging latches adapted to allow the second side face attached to the front door to open, thereby allowing side access to the swing gate and allowing equipment mounted on the swing gate to fully swing open without physical interference by the enclosure.

In an exemplary embodiment, the mounting location is a raised floor having a support structure and a vertically spaced partition plane. The support frame is mounted with respect to the support structure adapted to allow access to the equipment mounted on the swing gate by removing a floor tile associated with the partition plane, such that the support frame is horizontally mounted. In an exemplary embodiment, the support frame having a swing gate is mounted with respect to a support structure associated with a raised floor without a cabinet cover.

The present disclosure provides for an exemplary telecommunications equipment mounting assembly including a cabinet having walls defining an enclosed cavity, wherein at least one of the walls is a front door hingedly attached by a pair of hinges on a front face of the cabinet. The hinges are adapted to allow the front door to open and close along a pivotal axis defined by the pair of hinges. The cabinet is adapted to be mounted with respect to a particular mounting location and to allow access to the cavity when the front door is in the open position. The assembly further includes a swing gate pivotally mounted within the cabinet by a pair of aligned hinges adapted to host a plurality of telecommunications equipment members that are fully enclosed within the cavity when the front door of the cabinet is in the closed position. The cabinet is adapted to allow for the swing gate to open or close when the front door of the cabinet is open, thereby allowing for front side and/or rear side access to the equipment mounted on the swing gate. The aligned hinges are typically a pair of crooked arm hinges pivotally attaching the swing gate to the cabinet and positioning the swing gate offset into the cavity away from the front door of the cabinet.

The present disclosure further provides for an exemplary method for mounting telecommunications equipment, including the steps of: (a) providing a support frame having support members defining an opening to accommodate the telecommunications equipment and associated cabling within the support frame; and (b) hingedly attaching a swing gate to a front face of the support frame by a pair of aligned hinges for opening and closing the swing gate. The swing gate is adapted to host a plurality of telecommunications equipment members. The support frame is adapted to be mounted with respect to a particular mounting location.

In an exemplary embodiment, the mounting location can be a cabinet having walls defining a cavity to receive the support frame. The cabinet is typically mounted to a member selected from the group consisting of a planar support structure of a drop ceiling, a planar support structure of a raised floor, and a wall. At least one of the walls of an exemplary cabinet is a front door hingedly attached to at least one of the walls by a pair of aligned hinges to allow the front door to open and close. The front door is adapted to allow access to the swing gate when the front door is open. In exemplary embodiments, the hinges attaching the swing gate to the support frame are a pair of aligned crooked arm hinges pivotally attaching the swing gate to the support frame and positioning the swing gate offset from a front face of the support frame within the opening of the support frame.

Additional features, functions and benefits of the disclosed systems and methods will be apparent from the description which follows, particularly when read in conjunction with the appended figures.

### BRIEF DESCRIPTION OF THE DRAWINGS

To assist those of ordinary skill in the art in making and using the disclosed assemblies and methods, reference is made to the appended figures, wherein:

FIG. 1 is a schematic illustrating an exemplary cabinet mounting assembly having a front door in an open position;

FIG. 2 is a schematic illustrating a cabinet mounting assembly as shown in FIG. 1 with the front door and an exemplary swing gate in open positions;

FIG. 3 is an exemplary support frame including a swing gate having a pair of crooked arm hinges with the swing gate in a closed position;

FIG. 4 is a schematic illustrating the support frame of FIG. 3 shown with the swing gate in an open position;

FIG. 5 is a schematic illustrating an exemplary front side enclosure with the front door in a closed position;

FIG. 6 is a schematic illustrating the front side enclosure of FIG. 5 with the front door in an open position;

FIG. 7 is a schematic illustrating the front side enclosure of FIG. 5 with a partially detachable side face in an open position; and

FIG. 8 is a schematic illustrating an exemplary swing gate associated with the present disclosure;

FIGS. 9(a) and 9(b) are schematics illustrating an exemplary mounting cabinet associated with the present disclosure with the front door in a closed and open position respectively;

FIGS. 10(a) and 10(b) are schematics illustrating an exemplary mounting cabinet associated with the present disclosure with the front door and a partially detachable side face in an position and an exemplary swing gate in an open position respectively.

### DESCRIPTION OF EXEMPLARY EMBODIMENT(S)

The present disclosure provides for assemblies and methods for mounting telecommunication equipment effectively within various environments, including specifically a drop ceiling, a raised floor and/or a wall rack. An exemplary telecommunications frame assembly according to the present disclosure is operable to be utilized in at least three unique orientations: (i) mounted vertically with respect to a wall, wall rack and/or cabinet; (ii) mounted horizontally within a drop ceiling; and/or (iii) mounted horizontally within a raised floor. The frame assemblies allow for vertical and horizontal mounting of patch panels and telecommunications equipment. A frame assembly according to the present disclosure can be a standalone exposed assembly or fitted within an enclosure or cabinet.

An exemplary embodiment according to the present disclosure includes a cabinet having a built-in mounting frame. The present disclosure also provides for a cabinet adapted to enclose a standalone support frame. Enclosures can be sized, configured and/or customized to be effectively fitted in each of the previously described orientations. Typically, mounting telecommunications equipment within a ceiling orientation requires the complete assembly enclosure to meet building requirements for plenum-rated spaces. A ceiling mounted frame/enclosure assembly includes a rear plenum cover with fire-stopped cable entry for use in plenum-rated spaces.

An exemplary frame assembly associated with the present disclosure includes a rear support frame having cable entry points on all sides, including the rear side. Distribution cable management and slack storage areas can be built into the rear frame. The rear support frame can be connected to adjustable brackets to allow for vertical mounting of equipment or angled mounting of fiber panels on a rear plate of the frame.

The present disclosure provides for a frame assembly having a swing-out mounting frame with offset hinge points allowing the frame to swing out away from the support frame for rear termination of patch panels from outside of a cabinet, ceiling or floor. It is to be understood that the term “swing-out mounting frame” is interchangeable with the term “swing gate” for purposes of the present disclosure. In the overhead ceiling or floor horizontal mounting orientation, the swing gate can be attached to a control cylinder to control the opening and closing speed of the frame. The frame can include built in patch cord or cable management to facilitate passage of the cables from the front of the frame to the rear of the frame. In an exemplary embodiment, the frame is designed to be symmetrical to allow the swing gate to open from the left or right. The rear of the support frame typically defines mounting points to allow the frame assembly to be: (i) suspended within a cabinet positioned in a drop ceiling; (ii) mounted with respect to a wall or a cabinet standing upright; and (iii) suspended within a raised floor adapted to provide support to the sub-floor in a raised floor installation.

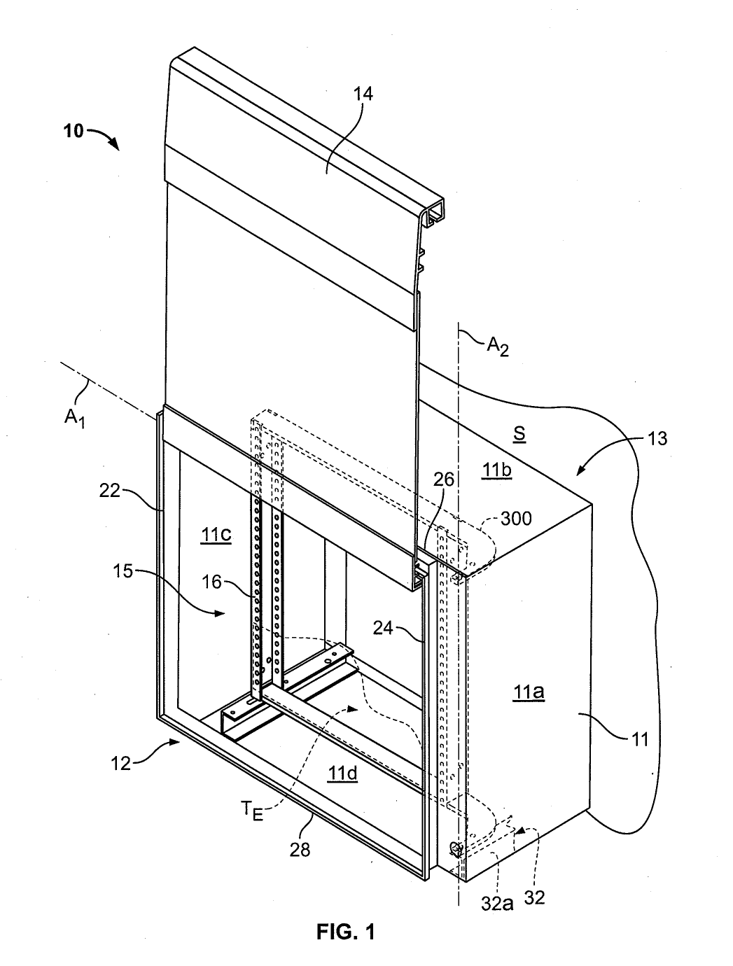

FIG. 1 illustrates an exemplary telecommunications cabinet assembly 10 configured to be mounted in various environments, e.g., within a drop ceiling, raised floor and/or with respect to a wall. Assembly 10 is particularly adapted to be mounted in a ceiling (not pictured), such that front face 12 faces downward toward a floor. Assembly 10 advantageously defines a plenum-rated enclosure.

Assembly 10 includes an enclosure 11 having walls defining an inner cavity 15. Enclosure 11 includes a front face 12 and a rear face 13. Front face 12 defines a first side 22 and second side 24. Front door 14 is pivotally mounted with respect to front face 12 and is shown in an open position allowing front access to inner cavity 15. Front door 14 can be pivotally mounted with respect to first side 22 or second side 24. FIG. 1 illustrates front door 14 pivotally mounted with respect to first side 22, i.e., at the left. Pivotally mounting front door 14 creates an axis of pivot for the front door.

Swing gate 16 (shown in a closed position) is pivotally mounted with respect to enclosure 11 by a pair of aligned hinges. Swing gate 16 is recessed relative to front face 12, i.e., recessed into cavity 15, to allow front door 14 to engage opposite second side 24 when front door 14 is in the closed position. In the closed position, front door 14 is adapted to engage second side 24 such that front door 14 will remain securely closed until physically disengaged from second side 24, e.g., by a system user.

Swing gate 16 is adapted to support telecommunications equipment, such as one or more patch panels. In addition, any cabling associated with the telecommunications equipment (e.g., patch panel(s)) is generally accommodated within cavity 15, i.e., rearward of swing gate 16. Cavity 15 should be large enough to allow full enclosure of telecommunications equipment mounted with respect to swing gate 16 and any cabling associated with the telecommunications equipment. Enclosure 11 generally defines at least one opening to allow for cables to lead into and lead out of assembly 10. In an exemplary embodiment, enclosure 11 defines a plurality of openings for cable pathways in and out of assembly 10.

Assembly 10 allows front side access to telecommunications equipment when front door 14 is in the open position without having to move the equipment external to cavity 15. For example, a user can perform front side cable patching on equipment mounted on swing gate 16 an unlimited number of times without ever having to physically open swing gate 16, thereby preventing excessive bending and/or movement of the equipment and rear side cabling. Moreover, with swing gate 16 in the closed position during front side cable patching operations, the overall structure exhibits greater strength and stability.

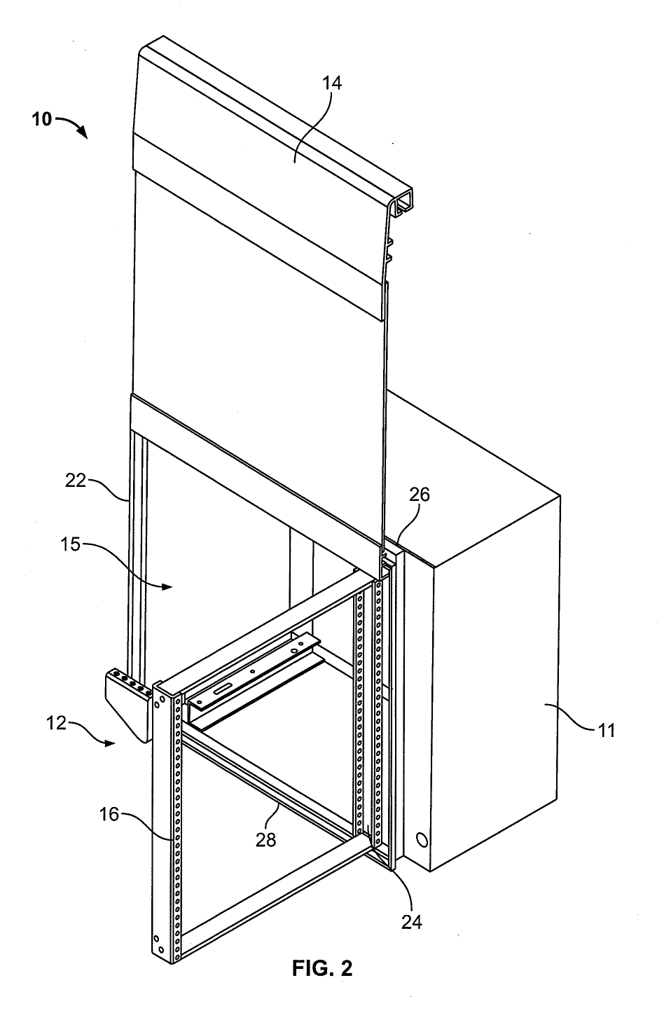

FIG. 2 illustrates exemplary assembly 10 with both front door 14 and swing gate 16 in open positions. As with assembly 10 shown in FIG. 1, assembly 10 is advantageously adapted to be ceiling mounted and defines a plenum-rated enclosure. Typically front face 12 defines four sides, first side 22, opposite second side 24, top side 26 and opposite bottom side 28. In FIG. 2, front door 14 is pivotally mounted with respect to top side 26 and swing gate 16 is pivotally mounted by a pair of aligned hinges with respect to adjacent second side 24. In FIG. 2, front door 14 and swing gate 16 pivot along axes that are perpendicular to each other. However, it is to be noted that front door 14 can be pivotally mounted with respect to any of sides 22, 24, 26 or 28. In an exemplary embodiment, swing gate 16 can be pivotally mounted with respect to the side supporting pivotal movement of the front door or the opposite side, i.e., the latching side for purposes of the front door. For example, if front door 14 is pivotally mounted with respect to top side 26 creating a pivoting axis along top side 26 as shown in FIG. 2, then swing gate 16 can be pivotally mounted with respect to first side 22 or opposite second side 24, establishing an adjacent pivoting axis, or opposite bottom side 28, establishing an opposite pivoting axis. Thus, the present disclosure provides assemblies with significant flexibility in orientation of the pivotal axes for the front door and swing gate members associated therewith.

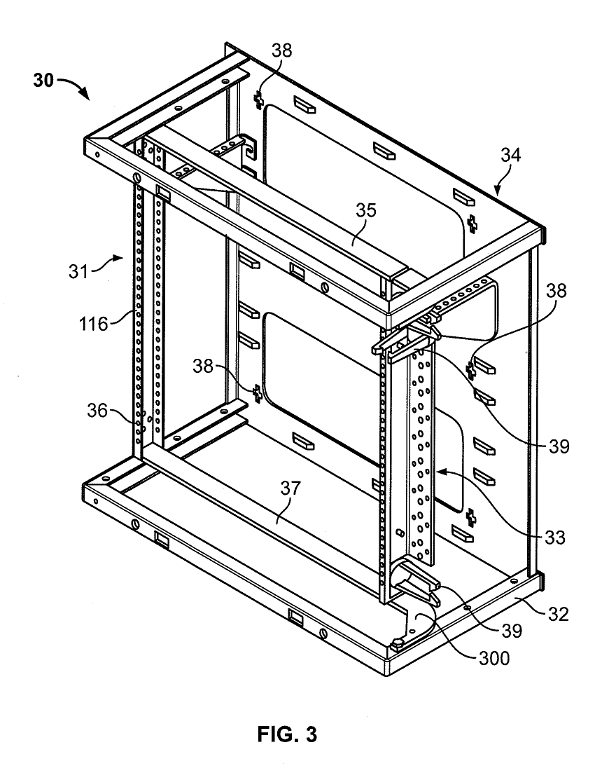

According to the present disclosure, FIG. 3 illustrates an exemplary telecommunications mounting assembly 30 adapted to be mounted within a cabinet and/or with respect to a wall, a support structure associated with a drop ceiling, or a support structure associated with a raised floor. Assembly 30 is operable to host a plurality of telecommunications equipment (not shown), including patch panels, typically mounted with respect to swing gate 116. Swing gate 116 typically includes a first mounting side 31, opposite parallel second mounting side 33, top side 35 and opposite bottom side 37. Top side 35 and bottom side 37 are in a parallel orientation and are connected with respect to mounting sides 31 and 33 to define a substantially rectangular/square structural arrangement. In an exemplary embodiment, mounting sides 31 and 33 each define a plurality of apertures 36 operable to allow mounting of telecommunications equipment, such as patch panels. As shown in FIG. 3, in typical implementations, apertures 36 are substantially aligned along the length of associated mounting sides.

FIG. 3 illustrates assembly 30 with swing gate 116 in a closed position. Assembly 30 includes support frame 32 and swing gate 116 pivotally mounted with respect to support frame 32. In an exemplary embodiment, swing gate 116 can be pivotally mounted by a pair of aligned hinges with respect to frame 32 on either mounting side 31 or mounting side 33, thereby allowing swing gate 116 to swing open along an axis defined by the aligned hinges. Frame 32 can include a pair of locking members (not shown), also referred to as latches, for securing swing gate 116 in a closed position and preventing swing gate 116 from undesired opening action. Exemplary locking members can interact with exemplary extending member protruding outwardly on side 33.

In an exemplary embodiment, support frame 32 can define a plurality of spaced apart mounting apertures 38 on a rear face 34. Apertures 38 allow for the mounting of assembly 30 onto or with respect to a desired mounting location and/or structure. Exemplary mounting locations and/or structures include a wall, a cabinet or a support floor. In a ceiling configuration, a plenum-rated cabinet is positioned within the drop ceiling and the cabinet is adapted to host an exemplary assembly 30 mounted within the cabinet by mounting members, such as screws/bolts and/or nuts engaging assembly 30 through apertures 38. The mounting members should secure assembly 30 within a cabinet.

An exemplary assembly 30 associated with the present disclosure can be mounted within a cabinet. An exemplary cabinet can be mounted with respect to a support structure associated with a drop ceiling, a support structure associated with a raised floor, standing alone within a room and/or mounted with respect to a wall. Assembly 30 allows for at least front side access to mounted telecommunications equipment when swing gate 116 is in an open position. Opening swing gate 116 allows for rear side equipment access for rear side cabling and terminations. In an exemplary embodiment, assembly 30 is mounted within a cabinet having a front door adapted to enclose assembly 30 when the front door is closed and allows access to assembly 30 when the front door is open. Opening the front door of the cabinet does not however open swing gate 116. Thus, an assembly according to the present disclosure allows for front side access to equipment, such as patch panels, for front patch work without the need to reposition the equipment, i.e., without the need to swing the equipment relative to the cabinet. The advantageous arrangement of the present disclosure significantly reduces wear and tear on the equipment cabling.

In exemplary embodiment, support frame 32 and swing gate 116 define a cavity adapted to accommodate telecommunications equipment and associated cabling within support frame 32. Assembly 30 can be mounted in a variety of environments, e.g., with respect to a wall, free standing outside a cabinet and/or mounted within a cabinet. In an exemplary embodiment, assembly 30 can be mounted within a raised floor or a drop ceiling. In a drop ceiling embodiment, assembly 30 should be enclosed within a plenum-rated cabinet. In a raised floor embodiment, assembly 30 can be mounted alone allowing access to the equipment mounted with respect to swing gate 116 when removing a floor tile positioned over the location of assembly 30. In an exemplary “standalone raised floor” embodiment, assembly 30 further includes a dust shield (not shown) to protect the equipment during use. Assembly 30 can be mounted within a cabinet adapted to be securely positioned within a raised floor, allowing access to the front door of the cabinet when removing a floor tile positioned directly above assembly 30.

When assembly 30 is mounted in a plenum-rated cabinet (ceiling embodiment), a wall cabinet or a raised floor (either standing alone or within a cabinet), pivotal movement of swing gate 116 is only possible if the equipment mounted onto swing gate 116 is able to clear the surrounding cabinet enclosure and/or floor. Swing gate 116 should be adapted to swing open without interference from surrounding structure, such as a cabinet wall or floor. In an exemplary embodiment, swing gate 116 is pivotally mounted to the support frame by a pair of aligned hinges. In an exemplary embodiment, the hinges are a pair of crooked arm hinges 300 adapted to allow swing gate 116 to fully swing open when mounted within a cabinet or a raised floor. Crooked arm hinges 300 position the equipment mounted onto swing gate 116 offset or a sufficient distance away from a front door of a cabinet or a floor tile enclosing or surrounding assembly 30. Typically, crooked arm hinges 300 position the mounted equipment recessed within the cavity defined by the support frame 32 and the swing gate 116 as shown in FIG. 3.

In an exemplary embodiment associated with the present disclosure, assembly 30 includes at least one cable management clip 39 mounted with respect to swing gate 116. In a further embodiment, assembly 30 includes a plurality of clips 39. Clips 39 are adapted to secure cabling associated with mounted equipment to more effectively accommodate for limited space within a particular mounting location.

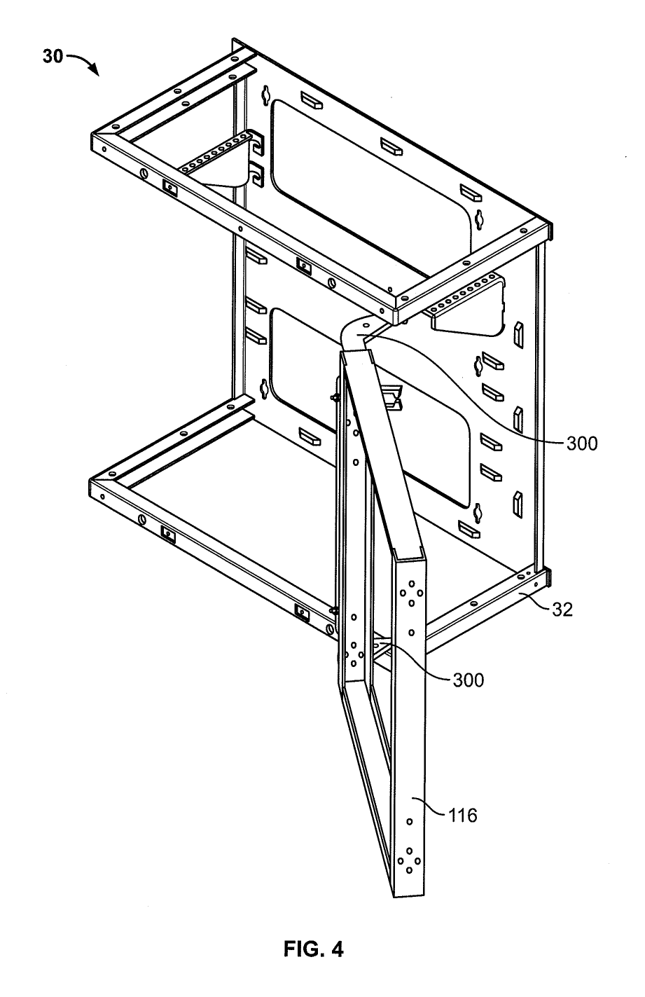

FIG. 4 illustrates assembly 30 of FIG. 3 with swing gate 116 in an open position. Hinges 300 are adapted to allow for equipment mounted onto swing gate 116 to clear surrounding enclosure structure. In an exemplary embodiment, hinges 300 are adapted to allow rotation of swing gate 116 to be greater than 90 degrees relative to the closed position. A greater freedom of rotation allows for more convenient rear termination access. In a floor mounted embodiment, for example, hinges 300 allow for swing gate 116 to swing upwards and around the edge of the floor making rear equipment access more convenient than traditional equipment mounting techniques.

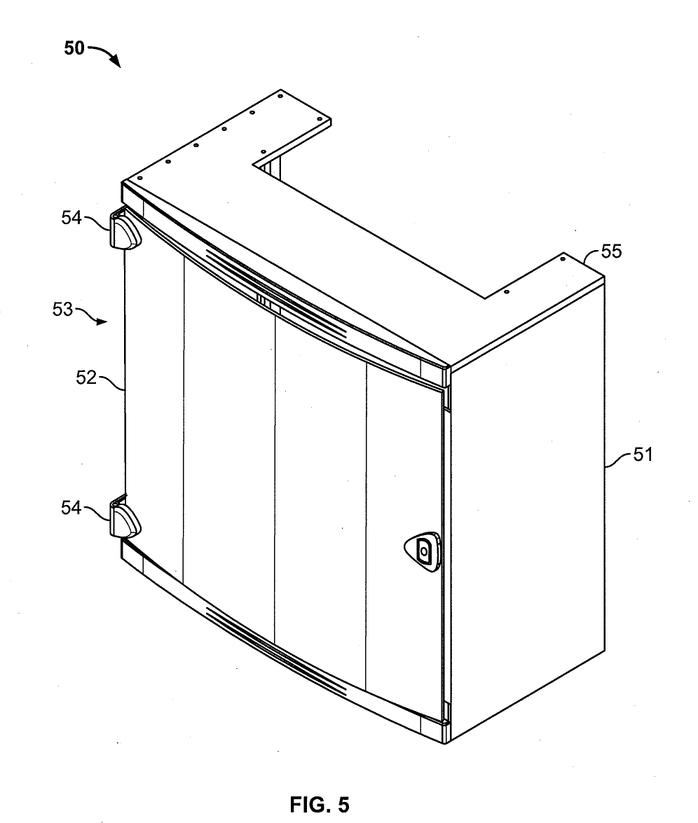

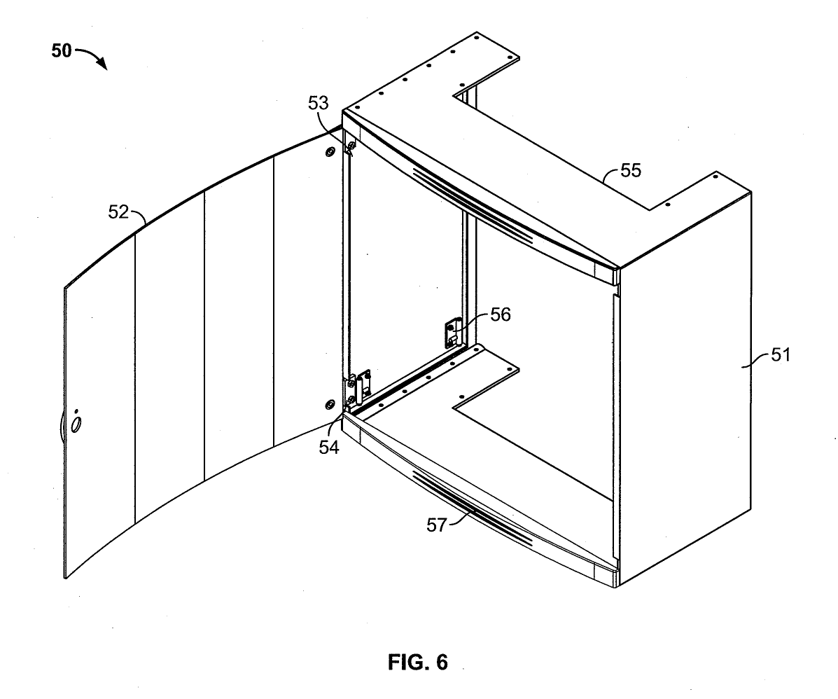

FIGS. 5 and 6 illustrate an exemplary enclosure 50 adapted to at least partially enclose an exemplary assembly 30. Enclosure 50 includes a front door 52 adapted to allow access to equipment mounted with respect to a swing gate 116 when front door 52 is in an open position, as shown in FIG. 6. Enclosure 50 includes a first side face 51 and an opposite second side face 53 adapted to prevent side access to equipment mounted with respect to assembly 30. Side face 53 is hingedly attached with respect to front door 52, typically via a pair of hinges 54 positioned opposite each other on a top front corner of side face 53 and a bottom front corner of side face 53. Hinges 54 allow front door 52 to rotate into an open position.

In an exemplary embodiment, side face 53 is detachably connected with respect to top face 55 and bottom face 57, typically via a pair of detachable latches 58 positioned adjacent to hinges 54. Side face 53 is also hingedly attached with respect to top face 55 and bottom face 57, typically by a pair of aligned hinges 56 positioned opposite each other on a bottom rear corner and a top rear corner of enclosure 50. Hinges 56 allow for side face 53 along with door 52 to open outwardly, allowing side access as well as front access to swing gate 116. Accordingly, a user can open front door 52 along hinges 54 allowing access to an exemplary assembly 30. The user can then further open enclosure 50 by partially detaching side face 53 from enclosure 50 by disengaging latches 58 and allowing side face 53 to pivot along hinges 56.

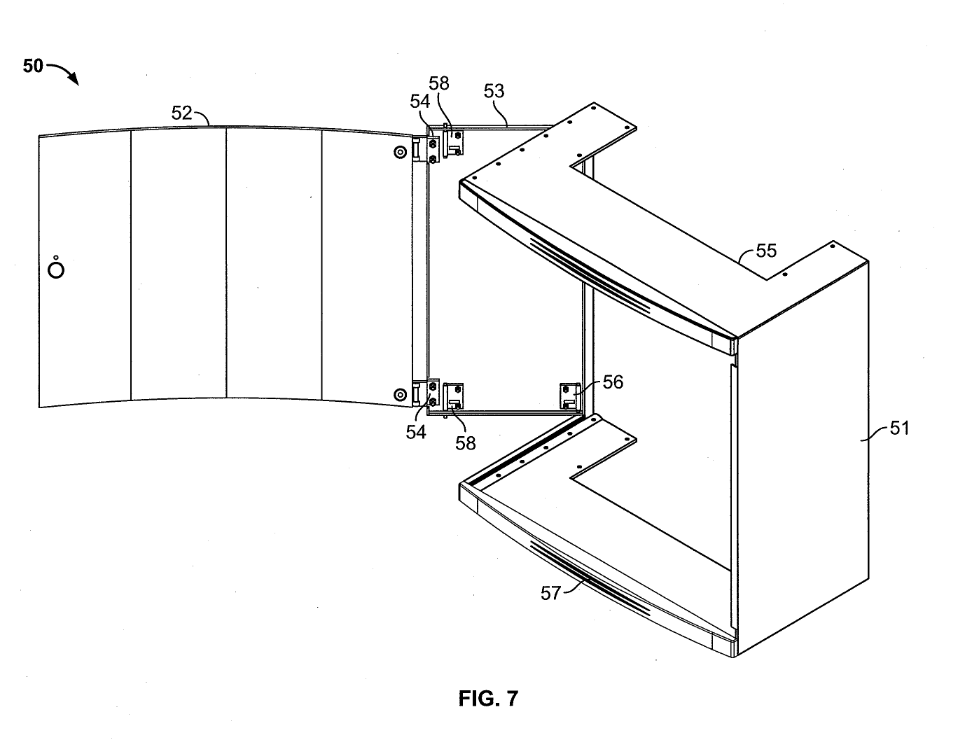

A double hinged (also referred to as a double pivot) embodiment as shown in FIGS. 5, 6 and 7, allows for mounting additional equipment with respect to an exemplary swing gate 116 within the enclosure. The additional space created by the opening of side face 53 allows for equipment mounted deeper with respect to swing gate 116 to clear side face 53 when opening swing gate 116. Typically, swing gate 116 and front door 52 pivot on opposite sides of an assembly associated with the present disclosure, although alternative arrangements may be employed.

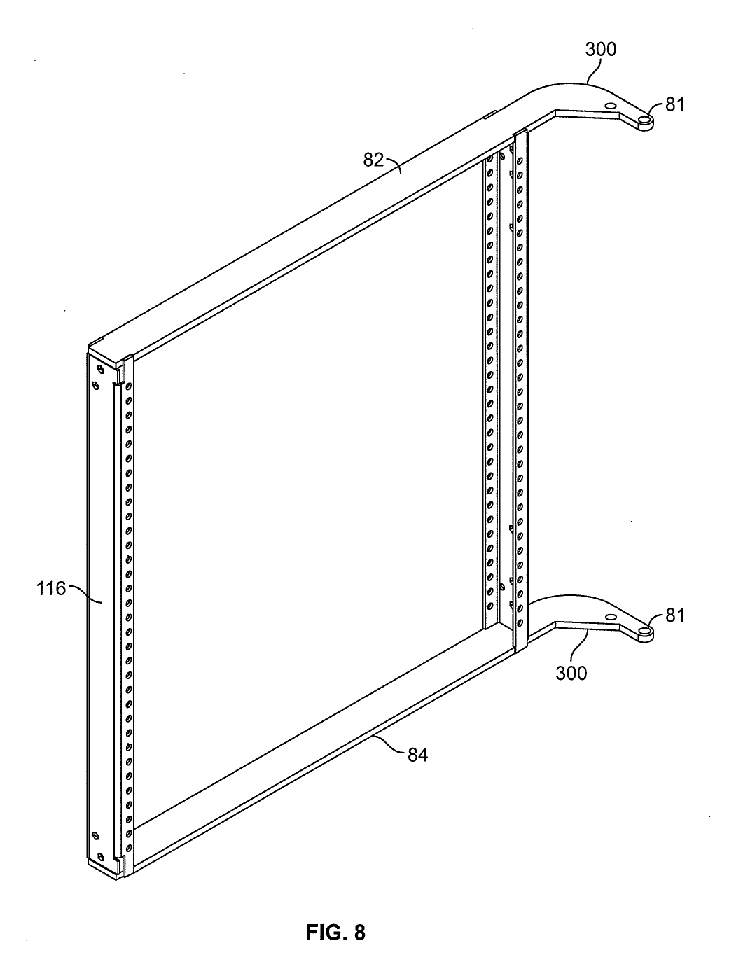

FIG. 8 illustrates an exemplary swing gate 116 adapted to be pivotally mounted with respect to a support frame as shown in FIGS. 3 and 4. Swing gate 116 includes a pair of crooked arm hinges 300 adapted to create a pivoting axis about a mounting structure. Hinges 300 typically each define at least one aperture 81 for receiving a pivoting member such as a bolt or screw. Swing gate 116 is pivotally mounted with respect to a support frame about the axis defined by the pivoting member. Crooked arm hinges 300 define a substantially curved geometry with the interior of the curve facing inwardly relative thereto. Top swing gate frame member 82 is parallel with bottom swing gate frame member 84. Members 82 and 84 are substantially aligned and are integral with crooked arm hinges 300. Crooked arm hinges 300 are thus extensions of members 82 and 84 curving towards a mounting point for pivotally mounting swing gate 116. The mounting of swing gate 116 via a pair of crooked arm hinges 300 positions any telecommunications equipment mounted with respect to swing gate 116 off-set from a front face of a cabinet or floor when swing gate 116 is in the closed position. Crooked arm hinges 300 allow for swing gate 116 and any associated telecommunications equipment to clear any supporting structure such as a cabinet or floor without physical interference from such structures when swing gate 116 is in the open position. Crooked arm hinges 300 allow for pivoting swing gate 116 to a greater then ninety degree angle with respect to the closed position and therefore advantageously allows for rear side access to telecommunications equipment mounted with respect to swing gate 116.

In an exemplary embodiment, assembly 30 of FIG. 3 can be mounted with respect to a wall and enclosure 50 can be mounted onto or with respect to assembly 30 so as to at least partially enclose assembly 30. Whether assembly 30 is mounted in a floor, ceiling or with respect to a wall, an enclosure according to the present disclosure is typically adapted to define at least one cable opening to allow for cables to be connected to equipment mounted within the enclosure and/or cabinet. In an exemplary embodiment, a mounting assembly according to the present disclosure further includes a rear mounting member adapted to host a plurality of telecommunications equipment. For example, patch panels are mounted onto an exemplary swing gate 116 and on a rear mounting member. This allows for more equipment to fit into a particular cabinet space.

Referring to a ceiling mounted embodiment, an enclosure according to the present disclosure can be two separate pieces, a front side enclosure and a rear side enclosure. An exemplary rear side enclosure is plenum-rated having fire stopped cable entry points and is adapted to: (i) be mounted in a drop ceiling; (ii) allow an equipment mounting assembly, such as exemplary assembly 30, to be mounted onto a rear face of the rear cabinet portion; and (iii) be securely attached with respect to the front cabinet portion, thereby enclosing the equipment mounting assembly. An exemplary front cabinet portion includes a front door adapted to match a particular ceiling tile arrangement. A front door matching the ceiling tile arrangement in a particular room allows for continuity in the look of a particular ceiling. In an exemplary embodiment, swing gate 116 further includes a control cylinder adapted to control the opening and closing speed of swing gate 116 when mounted in the drop ceiling or in the raised floor.

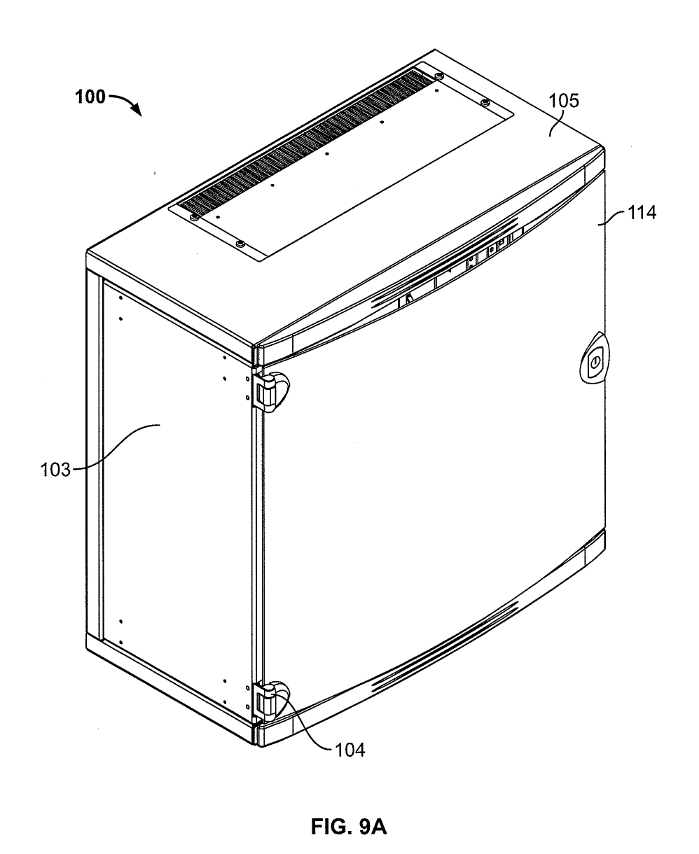

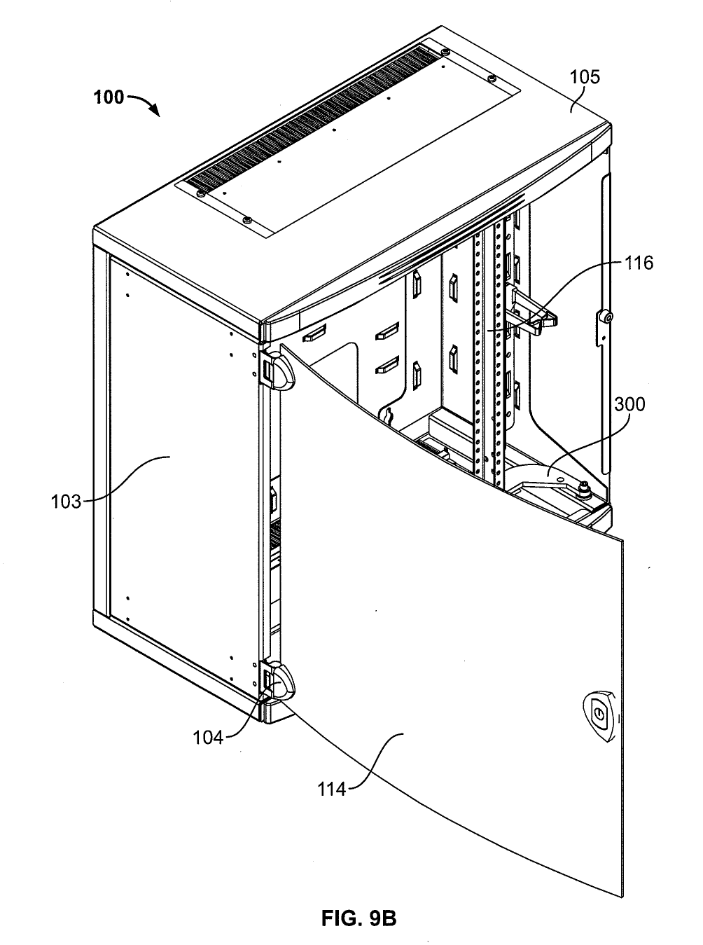

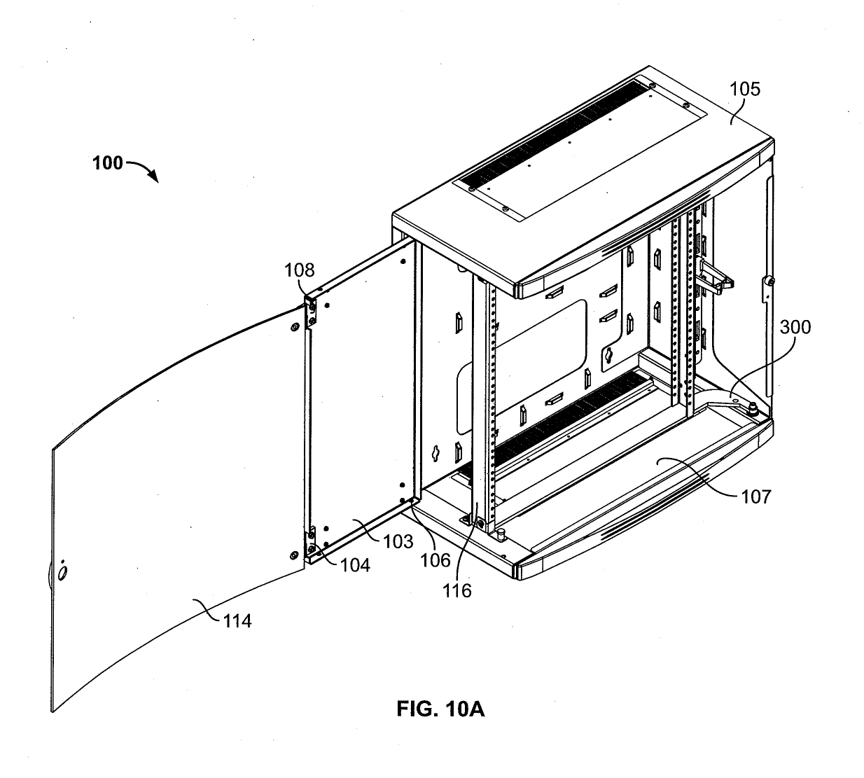

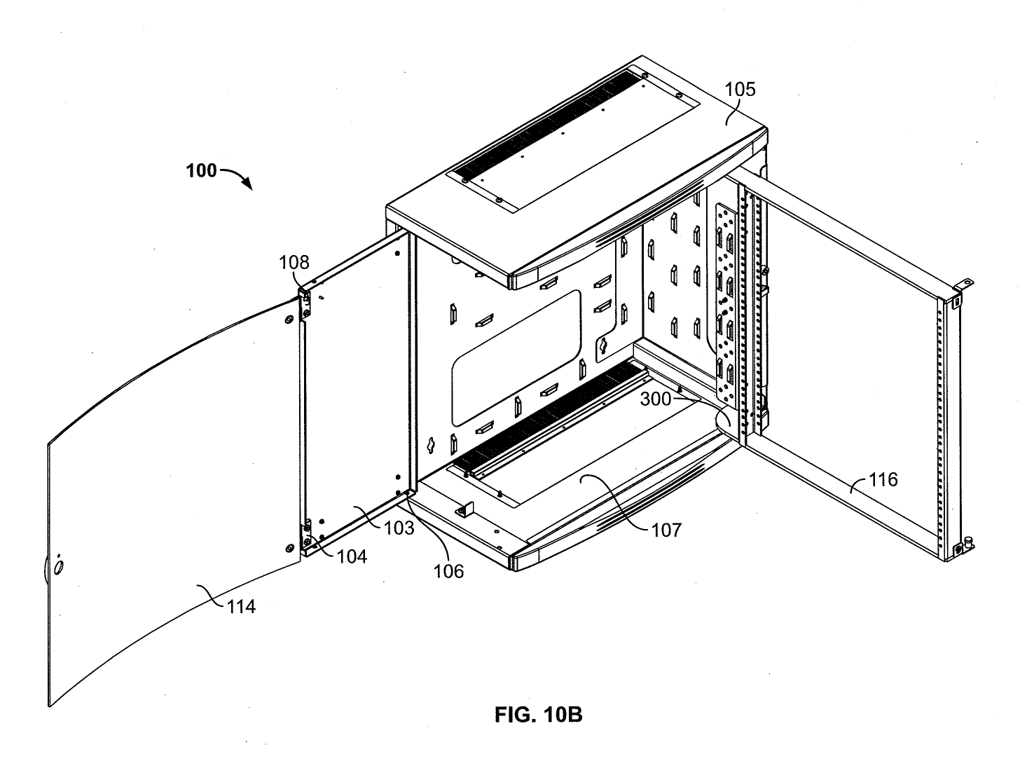

FIGS. 9(a), 9(b), 10(a) and 10(b) illustrate an exemplary cabinet 100 associated with the present disclosure defining a cavity for hosting telecommunication equipment within cabinet 100. In an exemplary embodiment, cabinet 100 is mounted with respect to a support structure within a drop ceiling and defines at least one fire stopped outlet to be operable within a plenum rated space. In a further exemplary embodiment, cabinet 100 is adapted to be mounted with respect to a support structure within a raised floor. In an even further embodiment, cabinet 100 is mounted with respect to a wall in a room or a telecommunications closet.

Exemplary cabinet 100 includes a front door 114 adapted to enclose telecommunications equipment mounted within the cabinet when in a closed position and allow access to the equipment when front door 114 is in an open position. In FIG. 9(a), assembly 100 is shown with front door 114 in a closed position thereby enclosing any equipment that may be mounted within the cavity of cabinet 100. FIG. 9(b) illustrates assembly 100 with front door 114 in an open position allowing front side access to equipment (not shown) mounted within the cavity of cabinet 100. Assembly 100 includes a swing gate 116 pivotally mounted within the cavity of cabinet 100 to allow swing gate 116 to rotate into an open position. FIG. 9(b) illustrates assembly 100 with swing gate 116 in a closed position. As described in FIG. 8, swing gate 116 includes a pair of crooked arm hinges 300 adapted to create a pivoting axis about a mounting structure.

Similar to exemplary enclosure 50 as described and illustrated in FIGS. 5, 6 and 7, assembly 100 includes a front door 114 adapted to allow access to equipment mounted on a swing gate 116 when front door 114 is in the open position, as shown in FIGS. 9(b), 10(a) and 10(b). Assembly 100 includes side face 103 adapted to prevent side access to equipment mounted within the cavity of assembly 100 when front door 114 is in the closed position as shown in FIG. 9(a). Side face 103 is hingedly attached with respect to front door 114 via a pair of hinges 104 positioned opposite each other with respect to a top front corner of side face 103 and a bottom front corner of side face 103. Hinges 104 allow front door 114 to rotate into an open position.

Referring to FIGS. 10(a) and 10(b), in an exemplary embodiment, side face 103 is detachably connected with respect to a top face 105 defined on assembly 100 and a bottom face 107 via a pair of detachable latches 108 positioned relatively adjacent to hinges 104. Side face 103 is also hingedly attached with respect to top face 105 and bottom face 107 by a pair of aligned hinges 106 positioned opposite each other with respect to a bottom rear corner and a top rear corner of assembly 100. Hinges 106 allow for side face 103 along with door 114 to open outwardly, allowing side access as well as front access to swing gate 116 and associated components. Accordingly, a user can open front door 114 along hinges 104 allowing access to an exemplary swing gate 116 and associated components. The user can then further open enclosure 100 by partially detaching side face 103 by disengaging latches 108 and allowing side face 103 to pivot along hinges 106.

A double hinged (also referred to as a double pivot) embodiment as shown in FIGS. 9(a), 9(b), 10(a) and 10(b), allows for mounting additional equipment with respect to an exemplary swing gate 116 within the enclosure. The additional space created by the opening of side face 103 allows for equipment mounted deeper with respect swing gate 116 to clear side face 103 when opening swing gate 116. Typically, swing gate 116 and front door 114 pivot along opposite and substantially parallel axes defined along appropriate hinges of an assembly associated with the present disclosure, although alternative arrangements may be employed.

Although the present disclosure has been described with reference to exemplary embodiments and implementations thereof, the disclosed assemblies and methods are not limited to such exemplary embodiments/implementations. Rather, as will be readily apparent to persons skilled in the art from the description provided herein, the disclosed assemblies and methods are susceptible to modifications, alterations and enhancements without departing from the spirit or scope of the present disclosure. Accordingly, the present disclosure expressly encompasses such modification, alterations and enhancements within the scope hereof.

1. A telecommunications equipment mounting assembly, comprising:
a support frame; and
a swing gate hingedly connected with respect to the support frame by one or more crooked arm hinges defining a pivot axis allowing the swing gate to open and close, the swing gate being adapted to host a plurality of telecommunications equipment mounted with respect to the swing gate;
wherein the support frame includes support members defining an opening for the telecommunications equipment to securely fit within the support frame when the swing gate is closed; and
wherein the support frame is mounted within a cabinet having walls defining a cavity to receive the support frame, said pivot axis remaining within said cavity at all times, including when the swing gate is open.

2. The mounting assembly according to claim 1, wherein the mounting location is a cabinet having walls defining a cavity to receive the support frame, the cabinet being mounted with respect to a member selected from the group consisting of a planar support structure of a drop ceiling, a planar support structure of a raised floor, and with respect to a wall.

3. The mounting assembly according to claim 2, wherein at least one of the walls of the cabinet is a front door hingedly attached to at least one of the remaining walls by a pair of aligned crooked arm hinges to allow the front door to open and close and the front door is adapted to allow access to the swing gate when the front door is open.

4. The mounting assembly according to claim 1, wherein the mounting location is a wall and the support frame is mounted vertically with respect to the wall.

5. The mounting assembly according to claim 1, wherein the mounting location is a support structure of a raised floor and the support frame is mounted horizontally.

6. The mounting assembly according to claim 1, wherein the hinges attaching the swing gate to the support frame are a pair of aligned crooked arm hinges positioning the swing gate off set from a front face of the support frame within the opening of the support frame.

7. The mounting assembly according to claim 6, wherein the crooked arm hinges are adapted to: (i) allow for the swing gate to clear an enclosing side of a cabinet or a floor when opening the swing gate; and (ii) rotate to a greater than ninety degree angle relative to a front face of the support frame.

8. The mounting assembly according to claim 3, wherein at least one of the walls is hingedly attached to a rear side of the cabinet by a pair of aligned pivoting hinges and is partially detachably connected to a front side of the cabinet by a pair of aligned disengaging latches adapted to allow the hingedly attached wall to open allowing side access to the swing gate and allowing equipment mounted on the swing gate to fully swing open without physical interference by the cabinet.

9. The mounting assembly according to claim 1, further comprising a control cylinder attached to the swing gate and adapted to control the opening and closing speed of the swing gate.

10. A telecommunications equipment mounting assembly, comprising:
(a) a front side enclosure having: (i) a top face; (ii) an opposite bottom face; (iii) a first side face; and (iv) an opposite second side face; wherein the faces are connected to define a substantially rectangular opening; the enclosure including a front door pivotally attached to the second side face adapted to allow the front door to pivot along an axis to open and close;
(b) a swing gate hingedly connected to a support frame by a pair of aligned crooked arm hinges to allow the swing gate to open and close, the swing gate is adapted to host a plurality of telecommunications equipment mounted onto the swing gate;
wherein the support frame includes support members defining an opening for the telecommunications equipment to securely fit within the support frame when the swing gate is closed;
wherein the enclosure at least partially encloses the support frame and allows front side access to the swing gate when the front door of the enclosure is open and allows for the swing gate to swing open allowing front and rear access to the telecommunications equipment mounted on the swing gate and access to the opening of the support frame; and
wherein the support frame is adapted to be mounted with respect to a particular mounting location.

11. The mounting assembly according to claim 10, wherein the hinges connecting the swing gate to the support frame are a pair of aligned crooked arm hinges positioning the swing gate off set from a front face of the support frame within the opening of the support frame spaced away from the front door of the enclosure.

12. The mounting assembly according to claim 11, wherein the crooked arm hinges are adapted to: (i) allow for the swing gate to clear the side faces of the enclosure when opening the swing gate; and (ii) rotate to a greater than ninety degree angle relative to the plane of the front door of the enclosure.

13. The mounting assembly according to claim 11, wherein the swing gate pivots along an axis adjacent and perpendicular to the pivot axis of the front door of the enclosure.

14. The mounting assembly according to claim 11, wherein the swing gate pivots along an axis opposite and parallel to the pivot axis of the front door of the enclosure.

15. The mounting assembly according to claim 10, wherein the support frame is mounted to a rear side enclosure adapted to attach to the front side enclosure to fully enclose the support frame and the telecommunications equipment mounted on the swing gate; wherein the mounting location is a drop ceiling having a planar support structure and a vertically spaced partition plane; and wherein the rear side enclosure is horizontally mounted to the support structure such that the front door of the front side enclosure is flush with the vertically spaced partition plane.

16. The mounting assembly according to claim 15, wherein the partition plane includes a plurality of ceiling tiles and the front door flush with the partition plane is adapted to match the look of the ceiling tiles.

17. The mounting assembly according to claim 15, wherein the rear side enclosure is plenum rated defining at least one fire stopped opening to allow for telecommunication cables connecting to the telecommunication equipment to enter and exit the enclosed space created by the front and rear side enclosure.

18. The mounting assembly according to claim 10, wherein the mounting location is a wall and the support frame is mounted vertically with respect to the wall.

19. The mounting assembly according to claim 18, wherein the second side face is hingedly attached to a rear side of the enclosure by a pair of aligned pivoting hinges and is partially detachably connected to a front side of the enclosure by a pair of aligned disengaging latches adapted to allow the second side face attached to the front door to open allowing side access to the swing gate and allowing equipment mounted on the swing gate to fully swing open without physical interference by the enclosure.

20. The mounting assembly according to claim 10, wherein the mounting location is a raised floor having a support structure and a vertically spaced partition plane and the support frame is horizontally mounted to the support structure adapted to allow access to the equipment mounted on the swing gate by removing a floor tile associated with the partition plane.

21. A mounting assembly for telecommunications equipment, comprising:
(a) a cabinet having walls defining an enclosed cavity wherein at least one of the walls is a front door pivotally attached on a front face of the cabinet by a pivot attachment adapted to allow the front door to open and close pivoting along an axis defined by the pivot attachment, the cabinet adapted to be mounted with respect to a particular mounting location and allowing access to the cavity when the front door is in the open position;
(b) a swing gate pivotally mounted by a pair of aligned crooked arm hinges within the cabinet adapted to host a plurality of telecommunications equipment fully enclosed within the cavity when the front door of the cabinet is in the closed position;
wherein the cabinet is adapted to allow for the swing gate to open or close when the front door of the cabinet is open allowing for front side or rear side access to the equipment mounted on the swing gate, the aligned crooked arm hinges remaining pivotally mounted within the cabinet at all times, including when the swing gate is open.

22. The mounting assembly according to claim 21, wherein the mounting location is a drop ceiling having a planar support structure and a vertically spaced partition plane, and wherein the cabinet is horizontally mounted to the support structure with the front door flush with the vertically spaced partition plane.

23. The mounting assembly according to claim 22, wherein the patrician plane includes a plurality of ceiling tiles and the front door flush with the partition plane is adapted to match the look of the ceiling tiles.

24. The mounting assembly according to claim 22, wherein the cabinet is plenum rated having at least one fire stopped opening to allow for telecommunications cables connecting to the telecommunications equipment to enter and exit the cabinet.

25. The mounting assembly according to claim 21, wherein the hinges connecting the swing gate to the cabinet are a pair of crooked arm hinges pivotally attaching the swing gate within the cabinet and positioning the swing gate off set into the cavity away from the front door of the cabinet.

26. The mounting assembly according to claim 25, wherein the crooked arm hinges are adapted to: (i) allow for the swing gate to clear the walls of the cabinet when opening the swing gate; and (ii) rotate to a greater than ninety degree angle relative to the plane of the front face of the cabinet.

27. The mounting assembly according to claim 21, wherein the mounting location is a wall within a room and the cabinet is mounted vertically with respect to the wall.

28. The mounting assembly according to claim 21, wherein the mounting location is a raised floor having a support structure and a vertically spaced partition plane and the cabinet is horizontally mounted to the support structure adapted to allow access to the cabinet by removing a floor tile associated with the partition plane.

29. The mounting assembly according to claim 21, wherein the swing gate pivots along an axis adjacent and perpendicular to the pivot axis of the front door defined on the front face of the cabinet.

30. The mounting assembly according to claim 21, wherein the swing gate pivots along an axis opposite and parallel to the pivot axis of the front door defined on the front face of the cabinet.

31. A method for mounting telecommunications equipment comprising the steps of:
(a) providing a support frame having support members defining an opening to fit telecommunications equipment and associated cabling within the support frame;
(b) hingedly attaching a swing gate to a front face of the support frame by a pair of aligned crooked arm hinges defining a pivot axis and for opening and closing the swing gate, the swing gate is adapted to host a plurality of telecommunications equipment;
wherein the support frame is adapted to be mounted in a cabinet having walls defining a cavity to receive the support frame, said pivot axis remaining within said cavity at all times, including when said swing gate is open.

32. A The method according to claim 31, wherein the cabinet is adapted to be mounted with respect to each of a ceiling, a floor, and a wall.

33. A The method according to claim 32, wherein at least one of the walls is a front door pivotally attached to at least one of the remaining walls allowing the front door to open and close, the front door is adapted to allow access to the swing gate when the front door is open.

34. A The method according to claim 31, wherein the hinges attaching the swing gate to the support frame are a pair of aligned crooked arm hinges positioning the swing gate off set from a front face of the support frame within the opening of the support frame.

35. A The method according to claim 34, wherein the crooked arm hinges are adapted to: (i) allow for the swing gate to clear an enclosing side of a cabinet or a floor when opening the swing gate; and (ii) rotate to a greater than ninety degree angle relative to a front face of the support frame.

36. A The method according to claim 33, wherein at least one of the walls is hingedly attached to a rear side of the cabinet by a pair of aligned pivoting hinges and is partially detachably connected to a front side of the cabinet by a pair of aligned disengaging latches adapted to allow the hingedly attached wall to open allowing side access to the swing gate and allowing equipment mounted on the swing gate to fully swing open without physical interference by the cabinet.

37. A The method according to claim 31, further comprising a control cylinder attached to the swing gate and adapted to control the opening and closing speed of the swing gate.
